(19) United States
(12) Patent Application Publication
(10) Pub. No.: US 2003/0127264 A1
(43) Pub. Date: Jul. 10, 2003

(54) Vehicle back-up safety system

(76) Inventor: David D. Johnson, Hortense, GA (US)

Correspondence Address: Peter A. Borsari, Esq., Borsari & Associates, P.C., Suite 206, 2001 Jefferson Davis Highway, Arlington, VA, 22202, US

(21) Appl. No.: 10/041,740

(22) Filed: Jan. 10, 2002

(51) Int. Cl. B62D 1/24

(52) U.S. Cl. 180/167; 180/169

(57) ABSTRACT

A vehicle back-up safety system comprising a sensing system for detecting the presence of an obstruction within a prescribed area behind the vehicle while a user is driving in reverse. In response to a signal from the sensing system signifying the presence of a an obstruction, a control means activates a fluid distribution system which draws brake fluid from the master brake cylinder and into the vehicle's brake line system, thereby activating the vehicle's brakes.

### FIELD OF INVENTION

The invention generally relates to vehicle back-up safety systems and more particularly relates to a vehicle back-up safety system having means for detecting the presence of an obstruction within close proximity to the vehicle and means for retarding or stopping the potentially dangerous rearward movement of a motorized vehicle having a hydraulic braking system.

### BACKGROUND OF THE INVENTION

As suburbia continues to grow and as land is subdivided into ever-smaller plots to accommodate new houses, apartment complexes and townhouses, population density rises inexorably creating a high vehicle density while failing to maintain road safety. Additionally, this traffic on our roads and in our neighborhoods subjects the vehicle driver, pedestrian, property, and especially children to the inherent risks automobiles pose.

A driver has great but limited control over his vehicle with respect to objects he can observe in front of his vehicle. However, a driver's field of view is obstructed in the area located behind his vehicle, making it difficult to see objects located or moving in this area as well as objects moving into this area while he is driving. The difficulty may be compounded when a driver is situated in a truck having a high rear section, for example, a delivery truck, garbage truck and the like. Moreover, because the driver's natural driving position faces toward the front of the vehicle, a distracted or inexperienced driver may fail to monitor this area adequately especially while driving in reverse. Small children, unaware pedestrians, animals and other drivers may be located and moving within this area in close proximity to the moving vehicle and may be unaware of the potential danger the vehicle poses. A driver's failure to stop his vehicle may result in fatal consequences.

Accordingly, many attempts have been made to warn a driver and/or to assist a driver in avoiding collisions with obstructions by providing means to sense the proximity of obj ects to the vehicle, to determine the imminence of contact and either to notify the driver by signaling means or to retard the movement of the vehicle automatically.

For example, the braking system taught by U.S. Pat. No. 4,574,908, issued Mar. 11, 1986 to Francis M. Brick utilizes an ultrasound sensing means to detect the proximity of objects to the user's vehicle. Brick's system scans to the rear of the vehicle only when the vehicle is in reverse. When an object is detected, the system utilizes a dual pressure accumulator to drive braking fluid into the vehicle's brake line. The dual pressure accumulator is assisted by compressed air which is injected into a central portion of the accumulator, as well as by power steering fluid which is pumped into a forward portion of the accumulator. Both the power steering fluid and the compressed air exert pressure on a pair of spring-biased pistons. In the event of a need to brake the vehicle, the power steering fluid and compressed air drive the pistons toward the rear of the accumulator, thereby driving the braking fluid out of the brake lines. Brick's apparatus requires the use of a vehicle having power steering fluid.

U.S. Pat. No. 4,864,298, issued Sep. 5, 1989 to Anthony E. Dombrowski discloses a driver alerting device which provides an audible alarm when a target is located within a prescribed area behind the vehicle. The device, operable when the vehicle transmission is engaged in reverse gear, uses a solenoid which is operatively connected to the air brakes of the vehicle and automatically applies the vehicle's brakes simultaneously with the audible signal. Other systems providing only audible alarm systems are illustrated in U.S. Pat. No. 4,797,673, issued Jan. 10, 1989 and U.S. Pat. No. 4,803,488, issued Feb. 7, 1989, both to Anthony E. Dombrowski.

Another automatic braking apparatus using ultrasound generating and transmitting means is shown in U.S. Pat. No. 5,170,858, issued Dec. 15, 1992 to Guo-Juh Chen. The apparatus further comprises an ultrasound receiver, a driving motor means and a brake master cylinder. The sensing ultrasound system is used to determine the proximity of the user's vehicle to another vehicle or object located in front of the user's vehicle. In the event that the user's vehicle is too close to sensed objects, an automatic braking means consisting of the motor means and the brake master cylinder engage the user's vehicle's braking system, forcing brake fluid into the brake lines. The brake master cylinder of Chen's automatic braking means is a secondary master cylinder which is inserted in parallel fashion to the vehicle's manual brake master cylinder.

U.S. Pat. No. 4,964,485, issued Oct. 23, 1990 to Jonathan R. Miele describes a device which senses impacts between a vehicle and objects located behind the vehicle when the vehicle is backing-up and automatically applies the brakes of a hydraulic brake system. Although designed for use on a vehicle having a hydraulic braking system, the device requires modifying the braking system by installing into the vehicle an air compressor and an air compressor-driven pneumatic cylinder. When an impact is sensed, the pneumatic cylinder is used to pull on the brake pedal to retard the vehicle's movement.

U.S. Pat. No. 4,407,338, issued Oct. 4, 1983 to James Steel discloses another collision prevention system that uses pneumatic means to stop a heavy vehicle when a moving object creates a hazard behind the vehicle moving in reverse.

The back up warning switch means for vehicles shown in U.S. Pat. No. 3,409,874, issued Apr. 11, 1966 to Robert P. Bowler sounds an audible alarm when the vehicle is in reverse only upon actual contact by a sensor with an object. Bowler estimates that six to ten inches stopping distance is sufficient for a vehicle moving in reverse at a slow speed.

The obstacle detection system for a vehicle shown in U.S. Pat. No. 5,235,315, issued Aug. 10, 1993 to James R. Cherry et al. provides a self test of the ground and signals the presence of significant objects in the vehicle's path by an audible alarm. Neither this system nor that described in U.S. Pat. No. 4,626,850, issued Dec. 2, 1986 to Young H. Chey are designed specifically to stop a vehicle which is in reverse gear when a moving object is detected to the rear of the vehicle. An auxiliary air brake system responsive to a detector member is provided in U.S. Pat. No. 4,591,019, issued May 27, 1986 to Brian Fisher et al. The auxiliary system is used in lieu of the existing braking system of a motor vehicle.

In U.S. Pat. No. 5,746,284, issued May 5, 1998 to David D. Johnson, the inventor of the present invention, a vehicle back-up safety device is described which utilizes a pair of electrically-motivated plunger assemblies to force fluid into the vehicle's brake line system, thereby activating the vehicle's brakes when an obstruction is detected near the rear of the vehicle. The present invention is an improvement of the Johnson vehicle back-up safety device disclosed in U.S. Pat. No. 5,746,284, the improvement being the use of a fluid distribution system in lieu of the plunger assemblies. U.S. Pat. No. 6,106,080 to Tozu et al. describes a brake control system including a modulator disposed between the master cylinder and a wheel brake cylinder that controls a hydraulic pressure pump for directing pressurizing brake fluid to the wheel brake cylinder in accordance with the switching valve's prescribed braking modes. However, Tozu et al. does not provide any proximity sensing means or override switch. Rather, Tozu et al. discloses only a braking system.

Despite the teachings of the prior art, a need still exists for an easily mountable backup safety system for stopping a vehicle having a hydraulic braking system when the vehicle is backing up. Such a system should apply the vehicle's brakes in response to a sensing means which has detected the presence of an obstruction within a specified range to the rear of the vehicle and which threatens imminent contact with the moving vehicle. In addition, such a vehicle back-up safety system should utilize a fluid distribution system which is in fluid communication with the vehicle's primary braking system in order to actuate the primary braking system.

### SUMMARY OF THE INVENTION

Accordingly, it is an object of the present invention to provide a vehicle back-up safety system for stopping a vehicle which is backing up when the presence of an obstruction is detected within a specified range of the rear of the vehicle.

It is another object of the present invention to provide a vehicle back-up safety system which brakes the vehicle by utilizing the hydraulic braking system already present in most vehicles.

It is also an object of the present invention to provide a vehicle back-up safety system which utilizes a fluid distribution system which is in fluid communication with the vehicle's primary braking system in order to actuate the primary braking system.

It is a further object of the present invention to provide a vehicle back-up safety system which employs an electrically generated signal for detecting the presence of an obstruction behind said vehicle.

It is still another object of the present invention to provide a vehicle back-up safety system which may be easily mounted to a vehicle.

It is yet another object of the present invention to provide a vehicle back-up safety system which includes an override switch which disables the electrical power to the sensing means, thereby enabling the vehicle to engaged in reverse gear.

It is an additional object of the present invention to provide a vehicle back-up safety system which is economical to manufacture, simple and durable in construction and effective in operation.

Additional objects, advantages and novel features of the invention will be set forth in part of the description which follows, and in part will become apparent to those skilled in the art upon examination of the following specification or may be learned by practice of the invention.

### BRIEF DESCRIPTION OF THE DRAWINGS

The present invention will be better understood with reference to the appended drawing sheets, wherein:

FIG. 1 is an environmental view of the vehicle back-up safety system installed in an automobile.

FIG. 2 is a schematic diagram of the back-up safety system of the present invention.

FIG. 3 is a environmental top perspective view showing the relative placement of fluid distribution system of the present invention and a vehicle's brake master cylinder and brake lines.

FIG. 4 is a simplified schematic diagram of an override switch utilized in the present invention.

### DETAILED DESCRIPTION

The present invention relates to an improvement of the vehicle back-up safety system disclosed in U.S. Pat. No. 5,746,284 to Johnson. The improved vehicle back-up safety system comprises a sensing system for detecting the presence of an obstruction in the proximity of the rear of the vehicle when the vehicle is engaged in reverse gear and a fluid distribution system in communication with the vehicle's braking system. More specifically, upon the detection of an object behind the vehicle, the sensing means generates an activating signal which triggers a control means to switch an electronic gate, thereby supplying electrical power to and activating the fluid distribution system. The fluid distribution system is in fluid communication with the vehicle's braking system in such a manner that the braking system is actuated when the fluid distribution system is activated, thereby causing the vehicle to brake.

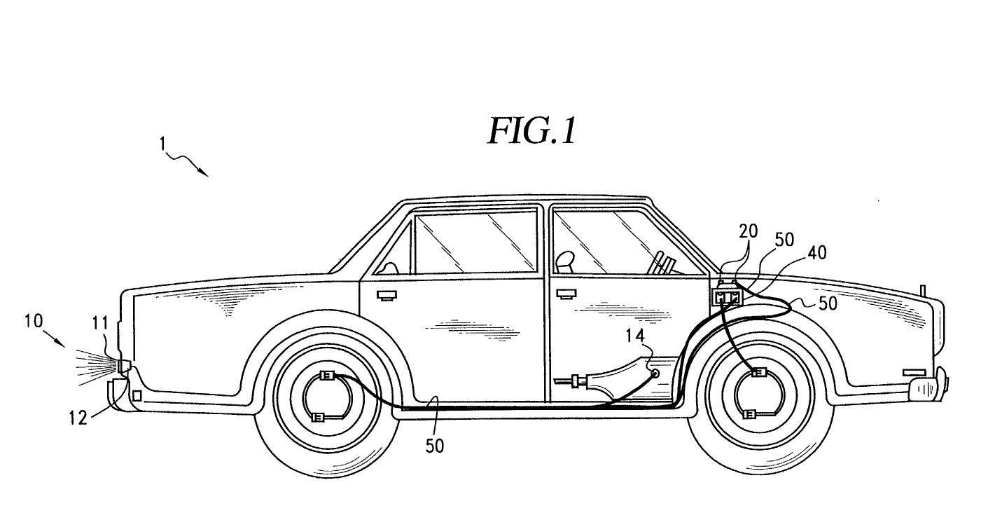

Referring now to FIG. 1, the improved vehicle back-up safety system (hereinafter sometimes referred to as the “back-up safety system” or “safety system”) is shown installed in a vehicle 1, the safety system comprising a sensing system 10, a control means 12 which electrically connects the sensing system 10 to a fluid distribution system 20. The fluid distribution system 20 is in in fluid communication with the vehicle's master brake cylinder 40 and brake lines 50.

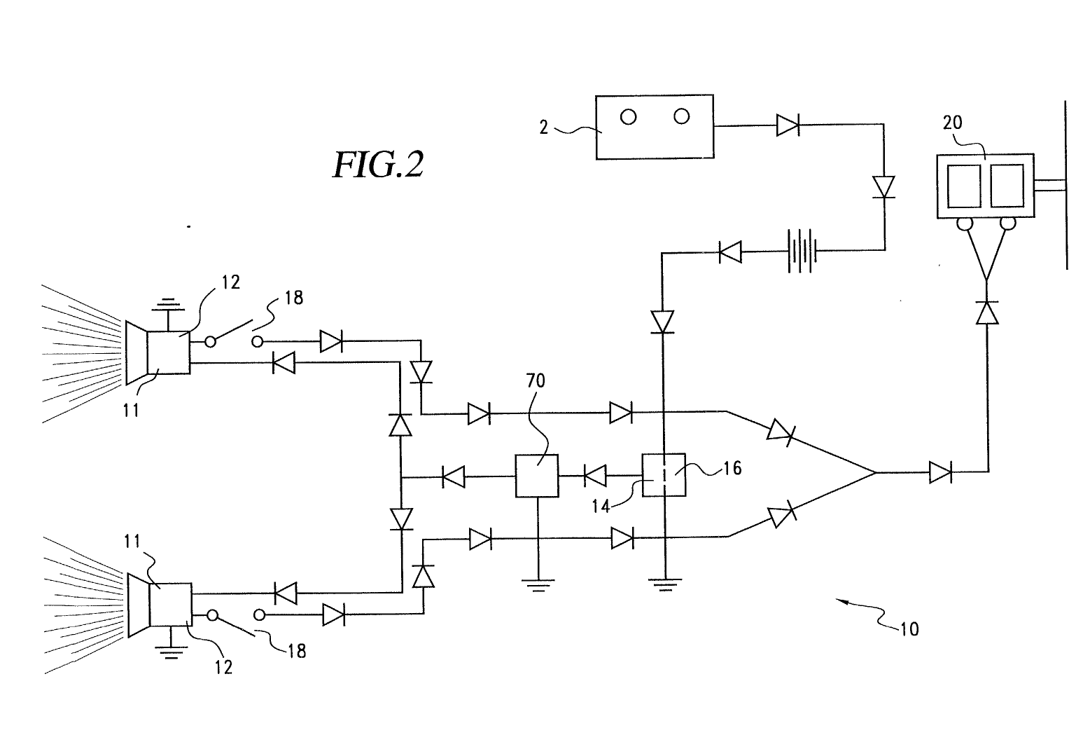

Referring now to FIG. 2, a schematic diagram is shown illustrating the sensing system 10 and the electrical connection to the vehicle 1 and fluid distribution system 20. The sensing system 10 comprises at least one sensing device 11 located at the rear of the vehicle. Preferably, the sensing system comprises two sensing devices 11, one located near each rear corner of the vehicle 1. In this manner, the sensing system is configure to monitor the entire region within a certain proximity behind the vehicle. A control means 12 electrically connects the sensing system 10 through an electronic switch 14 in order to provide the fluid distribution system 20 with electrical power in response to the detection of an obstruction by sensing system 10.

Still referring to the schematic diagram shown in FIG. 2, the sensing system 10 is connected to an electrical power source 2 through an electronic switch 14, such as a solenoid, a transistor or the like, which is wired in parallel with a reverse switch 16. Reverse switch 16 is the standard reverse switch found in the vehicle's transmission that activates the vehicle's back-up lights. The electrical wiring of the sensing system 10 in parallel with switch 16 ensures that the sensing system is automatically activated whenever the vehicle is engaged in reverse gear. In this manner, power is supplied to sensing system 10 only when the vehicle is in reverse gear. In a simplified alternative embodiment, the switch 14 can be omitted and the sensing system 10 simply can be connected in parallel with the reverse switch 16. Electrical power source 2 may be derived directly from the vehicle's electrical system, for example by patching into the vehicle's wiring harness, or may be derived from a separate battery, such as a twelve volt battery.

The sensing system 10 can be any suitable conventional sensing system well known in the prior art, including for example, infrared, laser or ultrasonic sensing devices. Regardless of the chosen sensing mode, the sensing means is characterized in having a transmitter for generating and transmitting an object detection signal and a receiver for receiving a reflection of the object detection signal off of an obstruction. The range of the object detection signal may be determined by the manufacturer's method of construction. Alternatively, the sensing means may be constructed to allow the user to pre-select a specified range. Preferably, the range should be at least twenty-two feet, the distance the vehicle will travel in one second at fifteen miles per hour. However, the prescribed range may be extended to provide a larger monitored region.

The sensing system 10 may be highly directional, as required by the sensing mode, and generates and transmits an activating signal to the control means 12 in response to receiving a reflected object detection signal. Means also may be provided to amplify the reflected signal. An example of such an amplifying circuit is schematically shown in U.S. Pat. No. 5,170,858 to Chen, numbered “22” in FIG. 1 thereof, and is expressly incorporated by herein by reference. Notwithstanding this express incorporation, other operational amplifier arrangements may be used to provide an efficient signal amplification means as is required by the chosen sensing means. The control means 12 preferably is connected to the power source 2 through the sensing system 10. When the control means 12 receives an activating signal from the sensing device 11, the control means closes a second electronic switch 18 in order to provide the fluid distribution system 20 with electrical power from the power source 2.

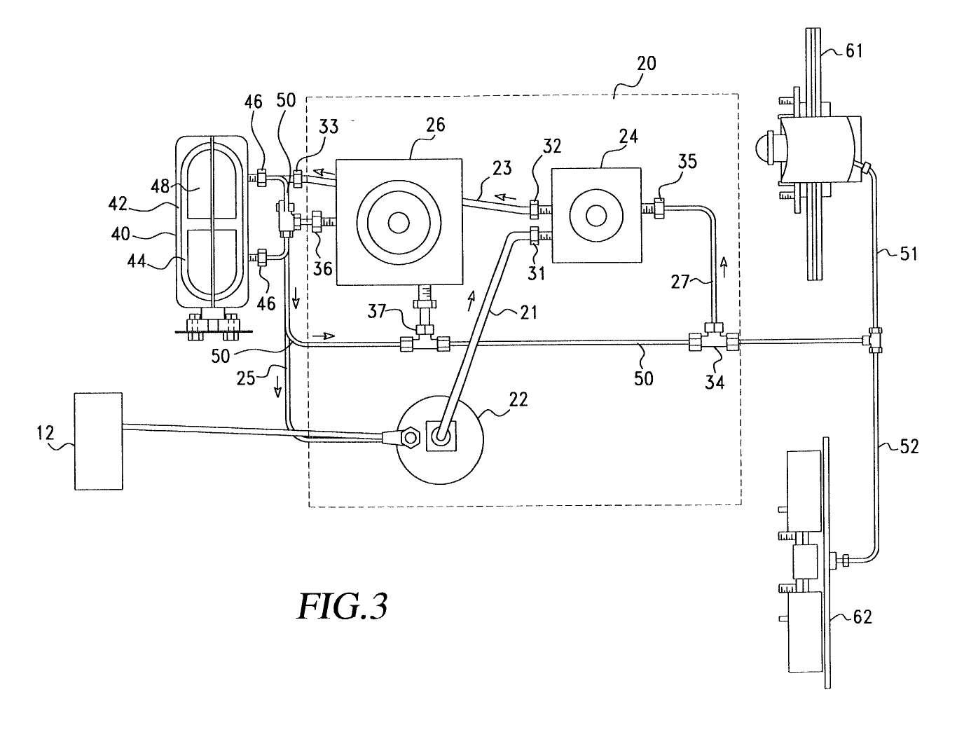

Referring now to FIG. 3, the fluid distribution system, generally designated 20, comprises a fluid distribution pump 22, a pressure switch 24 and an open/close valve 26, all of which are fixedly connected between the vehicle's master cylinder 40 and brake lines 50. The fluid distribution system further comprises a first fluid line 21, fluidly connecting the fluid distribution pump 22 and the pressure switch 24 by threaded engagement 31; a second fluid line 23, fluidly connecting the pressure switch 24 by threaded engagement 32 to the brake line 50 by threaded engagement 33, a brake fluid retrieval line 25, fluidly connecting the fluid distribution pump 20 to the master brake cylinder 40 and a bleed over fluid line 27 which is fluidly connected to brake line 50 by threaded engagement 34 and to pressure switch 24 by threaded engagement 35. The open/close valve 26 is fluidly connected to the master brake cylinder 40 by threaded engagement 36 and is fluidly connected to brake line 50 by threaded engagement 37.

The brake master cylinder 40 is a standard master cylinder used in conjunction with a most conventional hydraulic braking systems and comprises a body 42 having a cylinder cap 44 and a top filler cap 48. Master cylinder ball valves (not shown) control the conduction of braking fluid from the brake master cylinder 40 via outlets 46 into brake line 50 leading to the vehicle's brakes. The brake fluid retrieval line 25 is fluidly connected to the master brake cylinder 40 by threaded engagement to the outlets 46.

In normal vehicle operation, that is when the sensing means 10 has not been activated, open/close valve 26 is open and brake fluid flows from the master cylinder, through the open/close valve 26 and into brake line 50 at threaded engagement 37. When the fluid distribution pump 22 has been activated, open/close valve 26 is closed, and brake fluid flows directly into the brake line 50.

Upon activation of the fluid distribution pump 22, brake fluid is retrieved from the master cylinder through brake fluid retrieval line 25 and is pumped through first fluid line 21, through pressure switch 24, thereby causing open/close valve 26 to close, and through second fluid line 23 into the brake line 50. The brake fluid continues to flow from brake line 50 into brake lines 51 and 52 and to front brakes 61 and rear brakes 62 respectively, thereby activating the vehicle's braking system and stopping the vehicle's movement.

In operation, the back-up safety system of the present invention functions in the following manner. When the user engages his vehicle in reverse gear, switch 14 is closed, thereby supplying electrical power from power source 2 to electric sensing means 10. The sensing system's transmitter generates and transmits an object detection signal to a prescribed area behind the vehicle. Preferably, the transmitting signal is an infrared signal although as discussed above, any conventional sensing system may be utilized in the present invention. An obstruction located within the prescribed range of the signal will partially reflect the object detection signal to the sensing system's receiver. The receiver generates an activation signal which is subject to amplification and which is received by control means 12.

In response to the amplified activation signal, the control means 12 closes second electronic switch 18 thereby supplying electric power to and activating the fluid distribution pump 22 of the fluid distribution system. Brake fluid immediately is retrieved from the master brake cylinder 40 to the fluid distribution pump 22 and pumped through the pressure switch 24 and into the brake line 50.

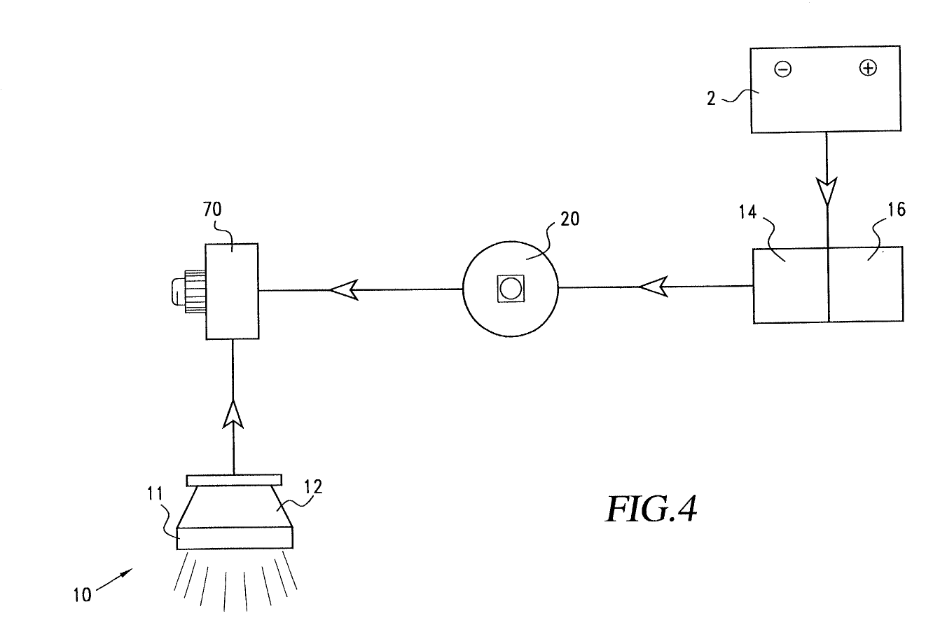

The back-up safety system of the present invention optionally may be provided with an override mechanism 70, as illustrated in FIGS. 2 and 4. Such an override mechanism may be in the form of a button, physical switch or similar device located within the vehicle and easily accessible to the driver. The override mechanism may be configured to enable an electrical switch to be opened at any point within the circuit joining the power source to the fluid distribution system, thereby breaking the circuit and disabling power to the fluid distribution pump 22. Use of the override mechanism may be required when a user desires to back his vehicle toward a perceived obstruction which is located within the prescribed range of the sensing means. The fluid distribution system also is disabled when the vehicle is engaged in reverse gear and no obstruction is detected by the sensing system 10, as well as when the vehicle is not engaged in reverse gear.

The instant invention can be fabricated as a kit having modularized components which are attached easily to the user's vehicle. A modularized sensing means can be mounted on the rear of the vehicle, having wire connections to the power source and to the vehicle's transmission reverse switch. Similarly, a fluid distribution system comprising the fluid distribution pump, pressure switch and open/close valve and the associated fluid lines can be provided for mounting between the master brake cylinder and brake lines.

While particular embodiments of the invention have been described, it will be understood, of course, that the invention is not limited thereto, and that many obvious modifications and variations can be made, and that such modifications and variations are intended to fall within the scope of the appended claims.

What is claimed is:

1. A vehicle back-up safety system connected to an electrical power source for automatically activating the hydraulic brakes of a vehicle upon detection of an obstruction within a prescribed area behind the vehicle, the vehicle having a master brake cylinder containing a brake fluid and being in fluid communication with the vehicle's brake lines, comprising:
(1) a sensing system for sensing the presence of said obstruction, said sensing system being electrically connected to said electrical power source and comprising a transmitter for generating and transmitting an object detection signal and a receiver for receiving a reflection of said object detection signal and for generating and transmitting an activating signal;
(2) a fluid distribution system in fluid communication with said master brake cylinder and said brake lines, said fluid distribution system comprising:
(a) a fluid distribution pump having a first fluid line and a brake fluid retrieval line in fluid communication with said master brake cylinder;
(b) a pressure switch connected to said fluid distribution pump through said first fluid line, and a second fluid line in fluid communication with said brake lines, and
(c) an open/close valve in fluid communication with said master brake cylinder, and
(3) a control means connected to said electrical power source and responsive to said activating signal from said receiver, said control means being configured for switching an electronic gate in response to said activating signal to provide electrical power to and to activate said fluid distribution pump.

2. The vehicle back-up safety system in accordance with claim 1, wherein said vehicle further comprises a standard reverse switch and wherein said sensing system is connected to said power source by means of an electronic switch.

3. The vehicle back-up safety system in accordance with claim 2, wherein said electronic switch is wired in parallel with said reverse switch such that said sensing system is automatically engaged whenever the vehicle is engaged in reverse gear.

4. The vehicle back-up safety system in accordance with claim 1, wherein said vehicle further comprises a standard reverse switch and wherein said sensing system is connected in parallel with said reverse switch.

5. The vehicle back-up safety system in accordance with claim 1, wherein said electrical power source is derived from the vehicle's main electrical system or from a separate battery.

6. The vehicle back-up safety system in accordance with claim 1, wherein said sensing system is at least one sensor device selected from the group consisting of infrared, laser and ultrasonic sensor devices.

7. The vehicle back-up safety system in accordance with claim 1, wherein when said fluid distribution pump is activated, brake fluid is drawn from said master brake cylinder, through said brake fluid retrieval line, into said fluid distribution pump, and through said first and second fluid lines and into said brake lines.

8. The vehicle back-up safety system in accordance with claim 7, wherein when said b rake fluid is drawn through said first fluid line to said pressure switch, said open/close valve is closed.

9. The vehicle back-up safety system in accordance with claim 1, further comprising an override mechanism.

10. The vehicle back-up safety system in accordance with claim 9, wherein said override mechanism is adapted to enable an electrical switch to be opened at any point within the circuit joining the power source to the fluid distribution system, thereby breaking the circuit and disabling power to the fluid distribution pump.

11. A vehicle back-up safety system connected to an electrical power source for automatically activating the hydraulic brakes of a vehicle upon detection of an obstruction within a prescribed area behind the vehicle, the vehicle having a master brake cylinder containing a brake fluid and being in fluid communication with the vehicle's brake lines, comprising:
(1) a sensing system for sensing the presence of said obstruction, said sensing system being electrically connected to said electrical power source and comprising a transmitter for generating and transmitting an object detection signal and a receiver for receiving a reflection of said object detection signal and for generating and transmitting an activating signal;
(2) a fluid distribution system in fluid communication with said master brake cylinder and said brake lines, said fluid distribution system comprising:
(a) a fluid distribution pump having a first fluid line and a brake fluid retrieval line in fluid communication with said master brake cylinder;
(b) a pressure switch connected to said fluid distribution pump through said first fluid line, and a second fluid line in fluid communication with said brake lines, and
(c) an open/close valve in fluid communication with said master brake cylinder;
(3) a control means connected to said electrical power source and responsive to said activating signal from said receiver, said control means being configured for switching an electronic gate in response to said activating signal to provide electrical power to and to activate said fluid distribution pump, and
(4) an override mechanism.

12. The vehicle back-up safety system in accordance with claim 11, wherein said vehicle further comprises a standard reverse switch and wherein said sensing system is connected to said power source by means of an electronic switch.

13. The vehicle back-up safety system in accordance with claim 12, wherein said electronic switch is wired in parallel with said reverse switch such that said sensing system is automatically engaged whenever the vehicle is engaged in reverse gear.

14. The vehicle back-up safety system in accordance with claim 11, wherein said vehicle further comprises a standard reverse switch and wherein said sensing system is connected in parallel with said reverse switch.

15. The vehicle back-up safety system in accordance with claim 11, wherein said electrical power source is derived from the vehicle's main electrical system or from a separate battery.

16. The vehicle back-up safety system in accordance with claim 11, wherein said sensing system is at least one sensor device selected from the group consisting of infrared, laser and ultrasonic sensor devices.

17. The vehicle back-up safety system in accordance with claim 11, wherein when said fluid distribution pump is activated, brake fluid is drawn from said master brake cylinder, through said brake fluid retrieval line, into said fluid distribution pump, and through said first and second fluid lines and into said brake lines.

18. The vehicle back-up safety system in accordance with claim 17, wherein when said brake fluid is drawn through said first fluid line to said pressure switch, said open/close valve is closed.

19. The vehicle back-up safety system in accordance with claim 11, wherein said override mechanism is adapted to enable an electrical switch to be opened at any point within the circuit joining the power source to the fluid distribution system, thereby breaking the circuit and disabling power to the fluid distribution pump.
